(19) United States
(12) Patent Application Publication
(10) Pub. No.: US 2013/0180169 A1
(43) Pub. Date: Jul. 18, 2013

(54) CANOPY MATERIAL

(71) Applicant: Jonathan Dallas Toye, Rosedale (NZ)

(72) Inventor: Jonathan Dallas Toye, Rosedale (NZ)

(73) Assignee: EXTENDAY IP LIMITED, Rosedale, Auckland (NZ)

(21) Appl. No.: 13/810,059

(22) PCT Filed: Jul. 15, 2011
(86) PCT No.: PCT/NZ11/00135

§ 371 Date: Apr. 2, 2013

(30) Foreign Application Priority Data
Jul. 15, 2010 (NZ) 586819

(51) Int. Cl. A01G 13/00

(52) U.S. Cl. CPC A01G 13/0206
USPC 47/32.3; 428/220; 428/192; 442/181; 428/156; 428/157; 428/136; 428/193; 524/413; 524/420; 524/425; 524/423; 524/433; 524/424

(57) ABSTRACT

A canopy sheet material for use over growing plants such as grape or berry or other fruit vines has higher water permeability in a longitudinally extending substantially center lengthwise part (33) than in lengthwise side parts (34). In use rain falling on the canopy runs down the side parts (34) and drains through the center part (33) to approximately the center of each tree or vine which keeps water away from the fruit under the less water permeable side parts (34).

### FIELD OF INVENTION

The invention relates to materials for use over growing plants such as grape or berry or other fruit vines, bushes, or trees (herein: plants) in agricultural applications.

### SUMMARY OF INVENTION

In broad terms the invention comprises a canopy sheet material having a greater length than width and having higher water permeability in a longitudinally extending substantially centre lengthwise part of the material than in lengthwise side parts of the material on either side of the more water permeable centre part.

Preferably in the side parts the material is substantially water impermeable.

Preferably the material or at least the side parts are transparent or translucent to transmit light to plants beneath the canopy material in use.

In some embodiments the material is white in colour.

In some embodiments the material is woven from warp and weft tapes.

In some embodiments the material is woven from warp and weft tapes and the permeability of the material in the centre part of the material is through the weave of the warp and weft tapes.

In some embodiments the material is woven from warp and weft tapes and the structure of the weave is altered in the centre lengthwise part of the material relative to the side parts of the material so that the weave is more water permeable such that water will more and relatively readily permeate through the centre part of the material than the side parts of the material.

In some embodiments at least some or a major fraction of or substantially all of the warp tapes have a greater thickness than the weft tapes in the higher water permeability centre lengthwise part of the material than in the lengthwise side parts of the material. In some embodiments the thickness of the warp or weft tapes is at least 50% or 100% or one to ten times or more greater than the thickness of the weft or warp tapes.

In some embodiments the warp tapes in the lengthwise side parts of the material have a rectangular or square cross-section and the warp tapes in the centre part of the material or at least some, a major fraction, or substantially all thereof have a circular or oval cross-section and are optionally thicker.

Typically the centre lengthwise part of the material is narrower across the length of the material than lengthwise extending side parts of the material. In some embodiments the centre lengthwise part of the material has a width of between 3 to 50 cm, or 5 to 30 cm or 8 to 15 cm, and the overall width of the material is between 1-8 metres, or 2 to 5 metres or 2.5 to 3.5 metres, for example.

Additionally, at least some, a major fraction, or substantially all of the warp and/or weft tapes may comprise slits through the tapes lengthwise of the tapes.

In some embodiments the tapes with slits through the tapes may comprise multiple parallel or approximately parallel slits.

The slits are shorter than the full length of the tape and in some embodiments may be of length in the range 1-20 mm, 1-10 mm, 5-15 mm, 2-8 mm, 9-11 mm, or 4-6 mm.

In some embodiments the length of spacing between slits may be in the range of 1-20 mm, 2-10 mm, or 4-6 mm.

In some embodiments the length of the slits is about the same as the lengthwise spacing between the slits.

In some embodiments, the slits are aligned with respect to their position across the width of the tape. If there are slit groups, each slit may be aligned with the corresponding slits of the remaining slit groups in the series. In other embodiments, the slits may not be aligned and could be staggered slits or in a random pattern along the length of the tape.

In some embodiments of the material of each of the above aspects of the invention the material is in the lengthwise centre part of the material is woven with a weave of tightness such that at least some, or at substantially all crossings of warp and weft tapes of the material the warp and weft tapes are at least butted against each other, or are pushed (or crammed) against each other, such that at least some of the warp and/or weft tapes are partly folded lengthwise (but for lateral apertures through the material as referred to further below).

In use the material is supported over the plant(s) as a canopy, for example by clipping or otherwise attaching lengthwise edges of the material to cables or wires along rows of plants on either side, in a garden, field crop, orchard or vineyard.

The sheet material will typically remain in place for some months, before being removed and reused in a subsequent growing season or on another crop in the same growing season, but in some cases may remain in place over multiple growing seasons.

In some embodiments the material may incorporate a compound or compounds added to cause or increase the extent to which the material reflects and/or absorption of radiation from the earth (terrestrial (long wave or infrared) radiation). Thus when the material is placed over plants it will assist in retaining heat beneath the material, which may be desirable for some plants or applications.

In some embodiments the material may incorporate a compound or compounds added to cause or increase the extent to which the material allows transmission and/or absorption of radiation from the earth (terrestrial (long wave or infrared) radiation). Thus when the material is placed over plants it will assist in releasing the heat beneath the material, which may be desirable for some plants or applications.

In other embodiments the material may incorporate a compound or compounds added to cause or increase the extent to which the material reflects and/or absorbs solar radiation. Thus when the material is placed over plants it will assist in cooling beneath the material, which may be desirable for some plants or applications.

In other embodiments the material may incorporate a compound or compounds added to cause or increase the extent to which the material allows transmission and/or absorption of solar radiation. Thus when the material is placed over plants it will assist in increasing the heat beneath the material, which may be desirable for some plants or applications.

In some embodiments the material may incorporate a compound or compounds added to cause or increase the extent to which the material diffuses solar radiation. Thus when the material is placed over plants it will assist in cooling beneath the material.

The term “tape” or “tapes” is intended to include longitudinally extending single filament elements having four sides when viewed in cross-section, such as a rectangular or square cross-section, also longitudinally extending elements having a multisided cross-section such as a triangular or hexagonal cross-section for example, and also longitudinally extending elements having a circular or oval or similar cross-section (sometimes referred to hereafter as monofilament). The tapes may be formed from any suitable polyolefin such as polyethylene or polypropylene, for example, or a mixture thereof, or an ethylene alpha-olefin, or a polyester, or a biopolymer, or a blend of any of the foregoing. Certain plastics are particularly useful when present as minor or major components. Ethylene vinyl acetate (EVA), ethylene butyl acrylate (EBA) and ethylene methyl acrylate (EMA) are useful for imparting elasticity and other properties. Polyesters and polystyrene, styrene-butdienie (SB), acrylonitrile-butadienie-styrene (ABS), styrene-aciylonitrile (SAN), polyethylenie terephithialate (PET), polymethylmethacrylate (PMMA) and polycarbonate are useful as dye carriers and also for influencing radiation (reflecting, absorbing and transmission) properties and also other properties on the materials. Starch and other plant polymers are useful to increase biodegradability.

The term “reflective” is intended to mean reflective of at least 10% or alternatively at least 20%, 30%, 40%, or 50% of visible light on at least one side of the material. In one embodiment of a reflective material the material may reflect at least 40% solar radiation on average across the UV (wavelength about 280-400 nm), visible (wavelength about 400-700 nm) and very near infrared (wavelength about 700-800 nm) ranges, and which transmits at least 10% or 5% on average of solar radiation across the wavelength range about 800-2500 nm. The material may reflect more solar radiation than it transmits and absorbs in the UV, visible, and very near infrared ranges. The material may transmit at least 15% or at least 20% of solar radiation on average in the wavelength range about 800-2500 nm.

The term “comprising” as used in this specification and claims means “consisting at least in part of”. When interpreting statements in this specification and claims which include the “comprising”, other features besides the features prefaced by this term in each statement can also be present. Related terms such as “comprise” and “comprised” are to be interpreted in similar manner.

### BRIEF DESCRIPTION OF THE DRAWINGS

The invention is further described by way of example with reference to the accompanying drawings in which:

FIG. 1 is a schematic stylised plan view of a section of woven canopy material of the invention;

FIG. 2 is a perspective view of the woven canopy material of the invention fixed over a row of vines;

FIG. 3 is a plan view of a length of material of a preferred embodiment of the invention;

FIGS. 4A and 4B are schematic perspective views showing the typical defining dimensions of rectangular and circular cross-section warp or weft tapes used to weave the canopy materials of the invention;

FIG. 5 is a very close up plan view of the lengthwise centre part of an embodiment of a canopy material;

FIG. 6 is a close up cross-section view of the lengthwise centre part of an embodiment of a canopy material of the invention in which there is a thickness differential between at least some of the warp and weft tapes; and

FIG. 7 is a close up cross-section view of the lengthwise centre part of another embodiment of a canopy material of the invention in which there is a thickness differential between at least some of the warp and weft tapes.

### DETAILED DESCRIPTION OF EMBODIMENTS

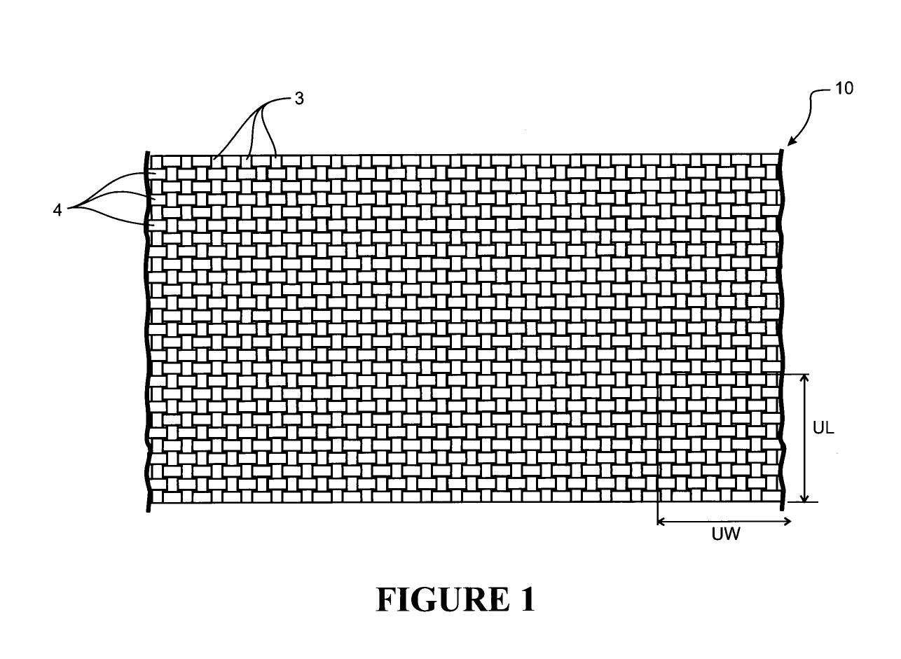

FIG. 1 shows a section of canopy material or sheeting 10. The material 10 is woven from flat warp 3 and weft 4 tapes of a plastics material. The tapes may be formed by extruding a film material from a polymer resin and then cutting the film into tapes which are in turn used to weave the material, or by extruding individual tapes. The tapes may be formed from a polymer containing pigments which give the canopy material desired properties, such as desired light reflective, absorptive, transmission and/or diffusive properties for example.

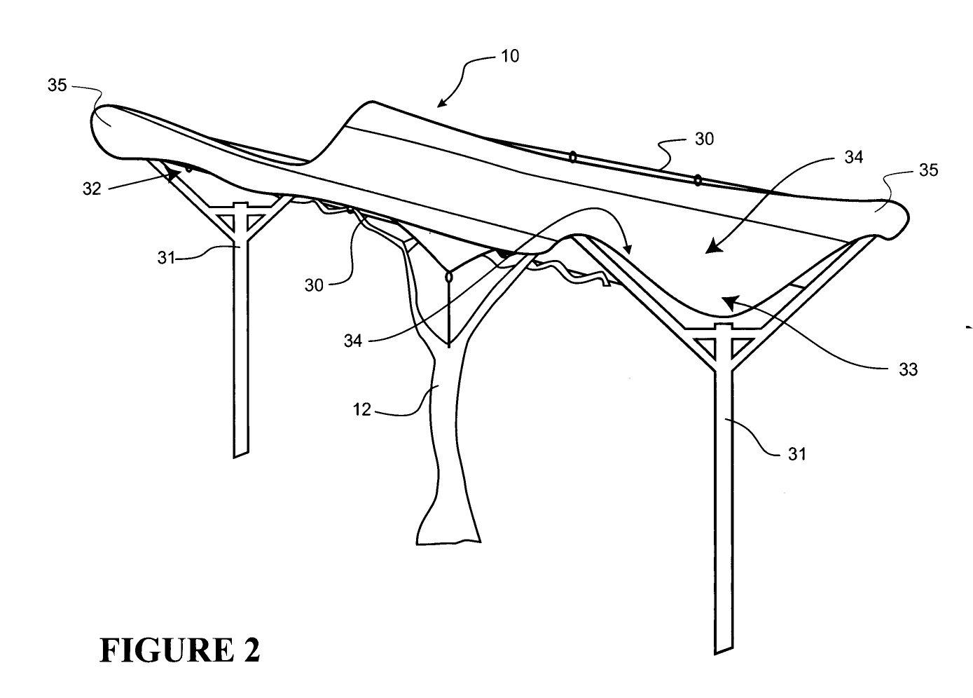

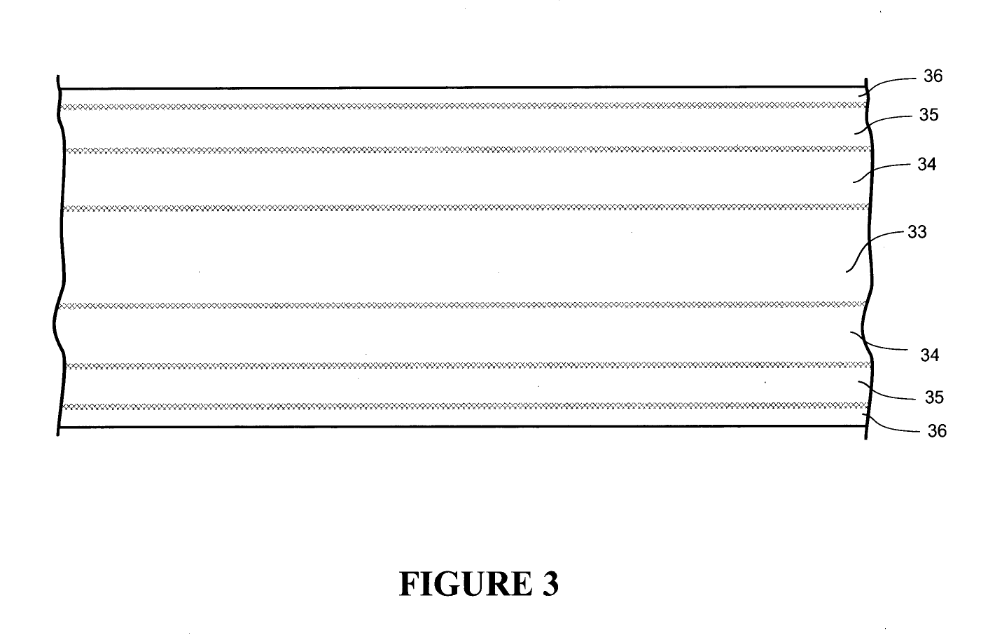

Typically the material has a greater length than width and is provided as a roll or in concertina folded form and referring to FIG. 2 lengths of the canopy material 10 can be fixed over rows of for example fruit vines or trees 12 as referred to previously. To anchor the material in place, optionally fastening clips 32 connect to the sheeting along its edges, and in turn to a wires 30 supported by posts 31, extending along the row of the trees or vines on either side. The material is woven from warp and weft tapes and, referring to both FIGS. 2 and 3, in lengthwise extending side parts 34 of the material is less water permeable than in lengthwise extending centre part 33 of the material, and in the side parts 33 is preferably substantially water impermeable, such that water will more and relatively readily permeate through the centre part of the material than the side parts of the material. In use rain falling on the canopy runs down the side parts 34 and drains through the centre part 33 to approximately the centre of each tree or vine which keeps water away from the fruit under the less water permeable side parts 34 of the material. Preferably the permeability of the centre part of the material is such that in use water can drain immediately through the centre part of the material without pooling.

The material may also comprise lengthwise extending outer parts 35 outboard of the side parts in which the material has higher permeability than in the side parts 34 to allow in use hot air beneath the material to escape upwardly through the outer parts 35. In one embodiment the permeability of the lengthwise extending outer parts 35 may be intermediate between that of the side parts 34 and centre part 33.

The material may further comprise lengthwise extending outermost edge parts 36 outboard of the outer parts 35 which may be formed to be of relatively high strength for attachment of hooks or clips to or through the material to anchor the material in place as described.

### Water Impermeable Side Parts

In the side parts 34 the material may have a tight weave or high weave density so that the side parts 34 have low or negligible water impermeability. Additionally or alternatively the side parts 34 may be coated with a continuous coating of a plastics material for example by extrusion coating at manufacture of the material. Alternatively again the side parts of the material may be heat treated to melt or partially melt bond the warp and weft tapes together in the side parts 34 to make the side parts water impermeable.

### Water Permeable Centre Parts

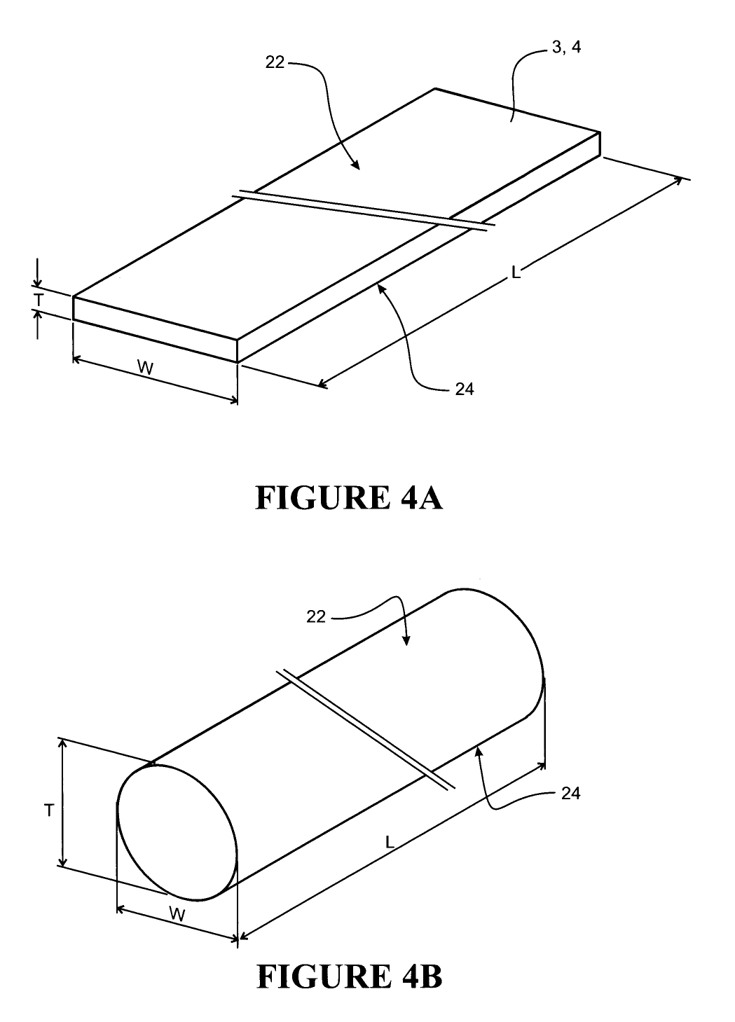

In the centre part 34 the material has high water permeability so that rain water may drain through the centre part. In some embodiments the structure of the weave is altered in the centre lengthwise part 33 of the material relative to the side parts 34 of the material so that the weave is water permeable or more water permeable in the centre part. The weave structure of the centre part is now described. First FIGS. 4A and 4B show dimensional profiles and/shapes of substantially rectangular and circular cross-section warp and/or weft tapes which may be used to weave the canopy material, for the purpose of further explanation of the various embodiments of the canopy material. The warp and/or weft tapes have an indefinite length, designated by reference double-ended arrow L. The top and bottom surfaces 22 and 24 of the tape form the top and bottom surfaces of the canopy material once woven. In this form the tapes are substantially rectangular in cross-section and have a width, designated by double-ended arrow W, and a thickness, designated by double-ended arrow T. It will be appreciated that the width and thickness of the tapes are substantially uniform along the length of the tape. In other forms the tapes may have different cross-section shapes as referred to previously.

### Differential Tape Width in Lengthwise Centre Part

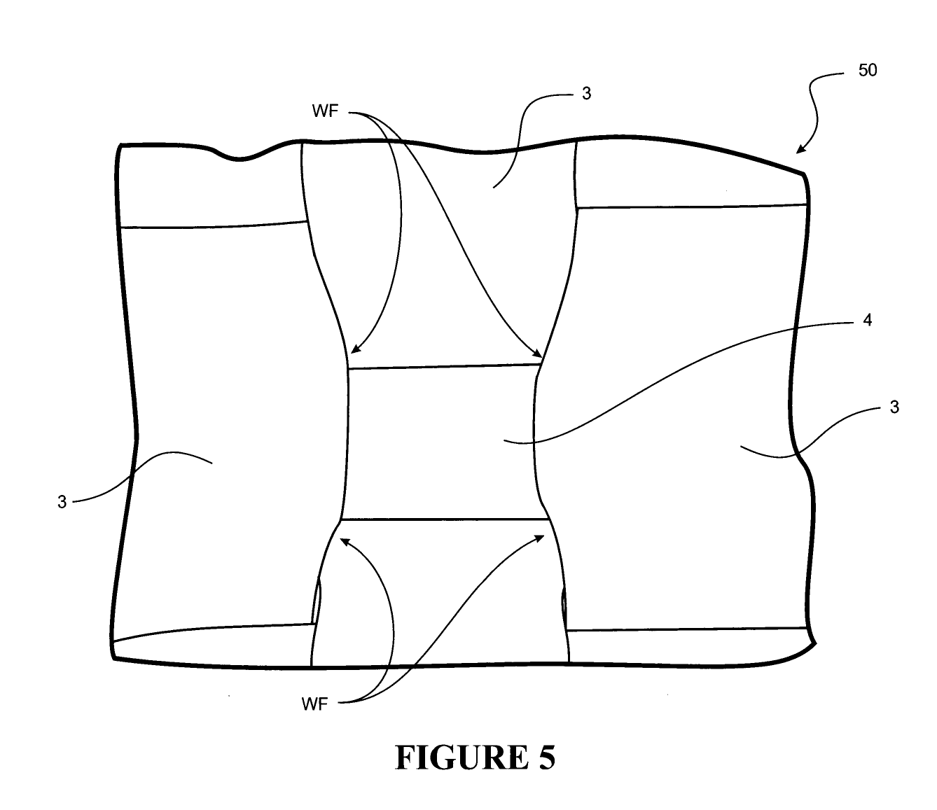

FIG. 5 is a very close up view of a section of the lengthwise centre section one embodiment of a canopy material 50 of the invention. In this embodiment the warp tapes 3 in the lengthwise centre section have a greater width (W) than the weft tapes 4. In FIG. 5 three warp tapes 3 and one weft tape 4 are visible. FIG. 5 shows a crossing between the weft tape 4 and the three warp tapes 3. The material in the lengthwise centre section may also be woven with a weave of tightness such that the edges of the warp and weft tapes are at least butted, or are crammed against each other (as subsequently described further), as shown.

The difference in width between the warp and weft tapes, along with the tight weave of the material, creates apertures substantially laterally between the warp and weft tapes, through the material, at each warp-weft crossing, through which water can flow, to in use drain through the centre of each tree or vine which keeps water away from the fruit under the less water permeable side parts of the material. For example in FIG. 5 water can flow through lateral apertures not visible but indicated by arrows WF, between the portion of the middle warp tape 3 shown, and the narrower weft tape 4, and beneath the side warp tapes 3.

At least some of the warp tapes in the lengthwise centre section have a greater width than the weft tapes. In one form, all the warp tapes have a greater width, but alternatively for example only every second or third warp tape may have a greater width than the weft tapes.

In the example shown the warp and weft tapes have a rectangular cross-section but in an alternative embodiment the warp or weft tapes may have a rectangular cross-section as shown, of width W, and the weft or warp tapes may have a circular or oval cross-section of a width (or diameter for a circular cross-section) less or greater than W.

### Differential Tape Thickness in Lengthwise Centre Part

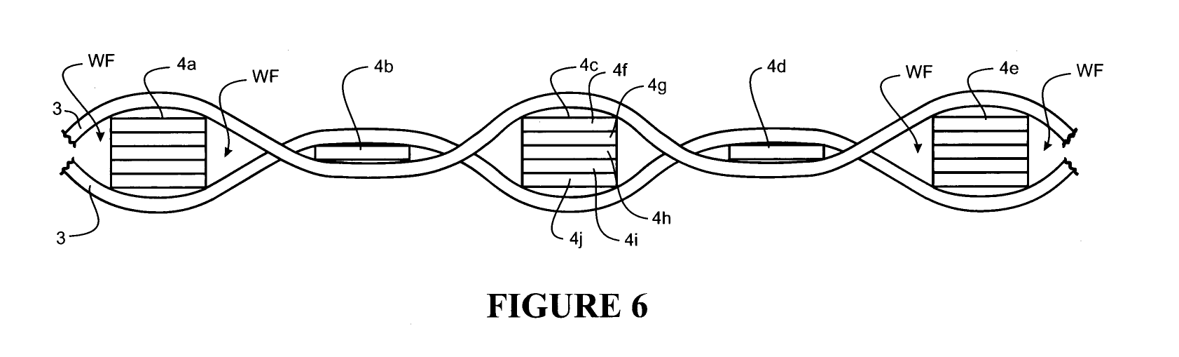

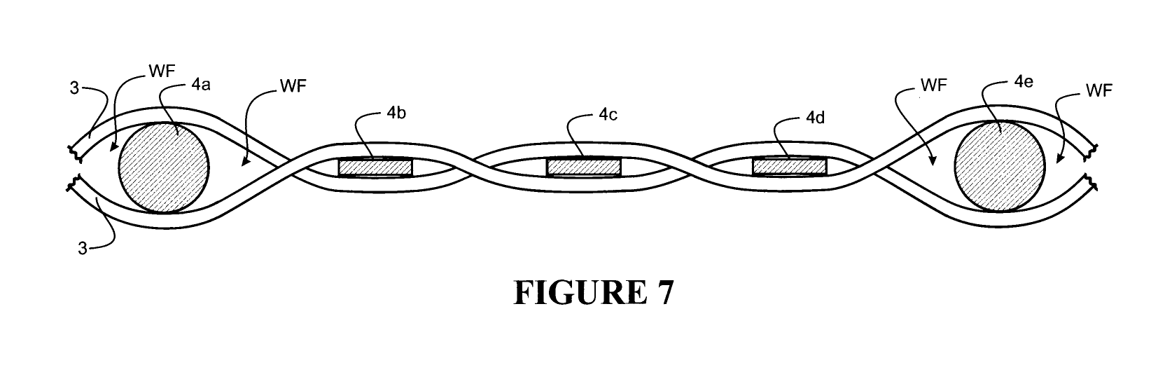

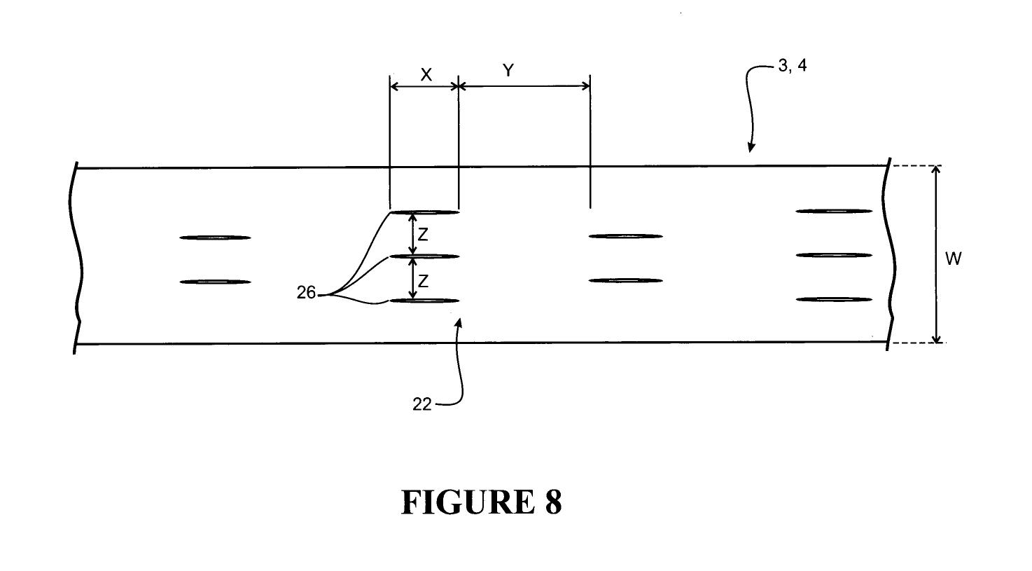

FIGS. 6 and 7 are close up cross-section views of the lengthwise centre section of two forms of a canopy material in which the warp tapes 3 have only a greater thickness (1) than the weft tapes 4. This thickness differential also creates substantially lateral apertures WF the material aligned with the warp tapes through which water can flow at the warp and weft tape crossings, similar to those created by the differential width embodiment described above. Again, the material may also be woven with a weave of tightness such that the edges of the warp and weft tapes are at least butted, or are crammed against each other, as shown.

FIG. 6 is a cross-section view of the lengthwise centre section of a material of this embodiment woven with tapes having a rectangular cross-section (as in FIG. 4A) and in which every alternate warp tape 4 has a five times greater thickness than the weft tapes 3 and also greater than the other warp tapes which have a thickness similar to the weft tapes 3, which is achieved by forming every alternate warp tape 4 of five rectangular filaments 4f-4j stacked i.e. each of the filaments 4f-4j has the same width W as the width of the resulting composite warp tape 4 but each has a thickness T of only ⅕^{th} of the total thickness T of the composite warp tape. The thickness differential between the thicker warp tapes and the weft tapes creates substantially lateral apertures WF either side of each thicker warp tape between adjacent weft tapes through which water can flow at the warp and weft tape crossings. Instead of every alternate warp tape being thicker as in the example of FIG. 6 all warp tapes or less than every alternate warp tape may have increased thickness. Also alternatively the alternate warp tapes 4 shown as each comprising five individual rectangular filaments stacked may instead comprise a single filament having a thickness T five times its width W. The thickness of the warp tapes may be more or less than five times that of the weft tapes. Where the warp or weft tapes with greater thickness comprise multiple individual filaments in such embodiments the warp or weft tapes with greater thickness may be composed of between 2 and 12, 4 and 8, or 5 or 6 individual filaments.

In a further form the warp tapes may comprise rectangular or square or other cross-section shape tapes of a similar thickness as the weft (or greater thickness) twisted along their length so that they have increased thickness. Again in the lengthwise centre section every warp tape or only some warp tapes may be so twisted.

FIG. 7 is a cross-section view of the lengthwise centre section of material woven with weft tapes 3 having a rectangular cross-section (as in FIG. 4A) and every fourth warp tape (or every 1 in 100 tapes or 1 in 50 tapes or 1 in 25 tapes or 1 in 10 tapes) such as warp tapes 4a and 4b shown have a circular cross-section (as in FIG. 5B) i.e. a monofilament plastics material, and in which the circular cross-section warp tapes 4a and 4e have a thickness T which is again five times the thickness of that of the weft tapes 3 and also greater than other warp tapes 4b-4d which have a rectangular cross-section and also a thickness similar to the weft tapes 3. The thickness differential between the thicker warp tapes and the weft tapes creates substantially lateral apertures WF either side of each thicker warp tape (4a and 4e) between adjacent weft tapes through which water can flow at the warp and weft tape crossings. Instead of every fourth warp tape being thicker as in the example of FIG. 7 more or less than every fourth warp tape including all warp tapes may have increased thickness. In an alternative form the monofilament may have an overall or other non-rectangular cross-section.

In the lengthwise centre section of the material the difference in thickness between the warp and weft tapes, along optionally with the tight weave of the material, creates apertures laterally between the warp and weft tapes, through the material, at each warp-weft crossing, through which water can flow. For example in FIGS. 6 and 7 water can flow through lateral apertures not visible but indicated by arrows WF, between the portion of the middle warp tape 3 shown, and the narrower weft tape 4, and beneath the side warp tapes 3.

### Fibrillated Tapes in Lengthwise Centre Part

FIG. 8 shows an example of the warp 3 tapes that can be used in the lengthwise centre part of the canopy material. FIG. 8 shows the top surface 22 of a section of the length of the tape 3,4 in which slits 26 piercing through the tape are provided along the length of the tape (“fibrillation”), such tapes being referred to herein as “fibrillated tapes”. In the preferred form, the tape 3, 4 comprise a series of spaced-apart slits 26 along the length of the tape. The orientation of the elongate slits is preferably substantially aligned with the longitudinal direction of the tape.

In one form, the tape 3, 4 may comprise a single series of slits along the length of the tape, but in alternative forms the tape may be comprise a series of slit groups, each slit group comprising two or more parallel or substantially parallel slits. For example, FIG. 8 shows the tape 3, 4 with a series of slit groups, each group comprising three parallel slits evenly spaced apart across the width (W) of the tape. As shown, each slits of each group are substantially aligned with corresponding slits in the adjacent slit groups of the series.

It will be appreciated that the slits need not necessarily be aligned lengthwise of the tape. They could alternatively be staggered across the width of the tape along its length to reduce any adverse effect on the strength of the tape. Any other slit pattern could alternatively be used, including random patterns along the length of the tape.

In the preferred form shown, the length of each slit, as designated by double-ended arrow X, is uniform along the length of the tape, although the length of the slits could vary in alternative forms. The slits or slit groups may be equi-spaced along the length of the tape 3, 4 by a distance designated by double-ended arrow Y, although non-equi-spacing could alternatively be employed in alternative forms.

The length (X) of the slits 26 are shorter than the full length of the tape and in some embodiments may be of length in the range of 1-20 mm, 5-15 mm, or 9-11 mm. The spacing of the slits depends on the slit length X, but in some embodiments may be in the range of 1-20 mm, 2-10 mm, or 4-6 mm. In one preferred form, the slit length X is approximately 10 mm with a spacing Y of approximately 5 mm. The spacing (designated by double-ended arrow Z) between the multiple slits across the width of the tape may be equal, and approximately 0.65 mm in one form when the overall tape width is 2.6 mm. In other forms the slits length X may be greater than the Y length. In some embodiments the length of the slits is about the same as the lengthwise spacing between the slits.

The slits may be formed by passing the tapes through a roller with short blades extending radially from the periphery of the roller, which act to cut or pierce short slits into the tape as it passes beneath the roller (and between an adjacent nip roller or another similar slitting roller). The slits may be formed as simply cuts in the tape, generated by cutting the tape apart, or as narrow slots by cutting out tape material at each slit. Alternatively, any other technique for creating the fibrillated tapes may be employed during the tape manufacturing process or after initial manufacture of the tapes.

The slits 26 create additional lateral apertures through the weave of the material through which water may in the lengthwise centre part of the material.

Fibrillated warp tapes having differential width and/or differential thickness as previously described can be used to weave the canopy material. The use of tapes of differential width and/or differential thickness creates lateral water flow apertures at the weave crossings in the lengthwise centre part of the material for easy water penetration through the material in combination with the apertures created by the slits. The material may also be woven with a weave of tightness such that the edges of the warp and weft tapes are at least butted, or are crammed against each other (as subsequently described further).

As stated the tapes may be formed from a polymer containing pigments which give the canopy material desired properties, such as desired light reflective, absorptive and/or transmission properties for example. Some or all tapes of a reflective material may be formed from a resin comprising a white pigment, which resin has been formed by mixing a masterbatch consisting essentially of 20 to 90% by weight of a white pigment or combination of pigments chosen from zirconium, strontium, barium, magnesium, zinc and calcium pigments, and a first polymer, with a second polymer such that the resin (masterbatch) comprising the white pigment comprises between about 5 to 50% by weight of the total mixture. In certain embodiments the white pigment may be selected from zirconium dioxide, magnesium zirconate, calcium zirconate, strontium zirconate, barium zirconate, zirconium silicate, zinc sulphide, calcium carbonate, barium sulphate, magnesium oxide, strontium carbonate, barium carbonate, and potassium titanate.

The foregoing describes the invention including preferred forms thereof. Alterations and modifications as will be obvious to those skilled in the art are intended to be incorporated in the scope hereof as defined in the accompanying claims.

1. A canopy sheet material having a greater length than width and having higher water permeability in a longitudinally extending substantially centre lengthwise part of the material than in lengthwise side parts of the material on either side of the higher water permeability center part, and wherein at least the side parts of the material are substantially water impermeable and are transparent or translucent, and the center part of the material is narrower across the length of the material than the side parts of the material and has permeability such that when substantially horizontal water can drain rapidly through the center part without pooling.

2. A canopy sheet material according to claim 1 wherein the center lengthwise part of the material has a width of at least 5 cm.

3. A canopy sheet material according to claim 1 wherein the center lengthwise part of the material has a width of at least 8 cm.

4. A canopy sheet material according to claim 1 also comprising lengthwise extending outer parts outboard of the side parts and in which the material has higher permeability than in the side parts

5. A canopy sheet material according to claim 4 wherein the permeability of the outer parts is intermediate between that of the side parts and the center part.

6. A canopy sheet material according to claim 4 or also comprising lengthwise extending outermost edge parts outboard of the outer parts.

7. A canopy sheet material according to claim 1 also comprising lengthwise extending outer most edge parts outboard of the side parts.

8. A canopy sheet material according to claim 1 which is white in color

9. A canopy sheet material according to claim 1 formed from a plastics resin comprising a white pigment.

10. A canopy sheet material according to claim 1 formed from a plastics resin comprising a white pigment selected from the group consisting of zirconium dioxide, magnesium zirconate, calcium zirconate, strontium zirconate, barium zirconate, zirconium silicate, zinc sulphide, calcium carbonate, barium sulphate, magnesium oxide, strontium carbonate, barium carbonate, and potassium titanate and mixtures thereof.

11. A canopy sheet material according to claim 1 wherein the material is woven from warp and weft tapes.

12. A canopy sheet material according to claim 4 wherein the material is woven from warp and weft tapes and the permeability of the material in the center part of the material is through the wave weave of the warp and weft tapes.

13. A canopy sheet material according to claim 4 wherein the material is woven from warp and weft tapes and the structure of the weave is altered in the center lengthwise part of the material relative to the side parts of the material.

14. A canopy sheet material according to claim 1 wherein warp tapes have a greater thickness than the weft tapes in the center part of the material.

15. A canopy sheet material according to claim 1 wherein warp tapes have a greater thickness in the center part of the material than in the side parts of the material.

16. A canopy sheet material according to any claim 1 wherein warp tapes in the side parts of the material have a rectangular or square cross-section and warp tapes in the center part of the have a circular or oval cross-section.

17. A canopy sheet material according to any claim 1 wherein warp and/or weft tapes comprise slits through the tapes lengthwise of the tapes in the center part of the material.

18. A canopy sheet material according to claim 1 wherein the material is in the center part of the material woven with a weave of tightness such that at crossings of warp and weft tapes of the material the warp and weft tapes are pushed or crammed against each other, such that warp and/or weft tapes are partly folded.

19. A canopy sheet material according to any one of claim 1 wherein the width of the material is between about 2.5 and about 3.5 metres meters.

20. A canopy sheet material having a greater length than width and having higher water permeability in a longitudinally extending substantially center lengthwise part of the material than in lengthwise side parts of the material on either side of the higher water permeability center part, and wherein at least the side parts of the material are substantially water impermeable and are transparent or translucent, and the center part of the material has permeability such that when substantially horizontal water can drain through the center part, the material also comprising lengthwise extending outer parts outboard of the side parts and in which the material has higher permeability than in the side parts, and the permeability of the outer parts being intermediate between that of the side parts and the center part.

21. A canopy sheet material according to claim 20 wherein the center lengthwise part of the material has a width of at least 5 cm.

22. A canopy sheet material according to claim 20 wherein the center lengthwise part of the material has a width of at least 8 cm.

23. A method which includes supporting over one or more plant(s) as a canopy a sheet material according to claim 1 so that rain falling on the canopy runs down the side parts and drains through the center part to approximately the center of the plant(s).

24. A method according to claim 23 which includes supporting the sheet material by clipping or otherwise attaching lengthwise edges of the material to cables or wires along rows of plants on either side, in a garden, field crop, orchard or vineyard.
